(19) United States
(12) Patent Application Publication
(10) Pub. No.: US 2026/0290350 A1
(43) Pub. Date: Sep. 24, 2026

(54) DYNAMIC USER VERIFICATION DETECTION BASED ON AUDIO OUTPUT DATA DURING PLAYBACK

(71) Applicant: QUALCOMM Incorporated, San Diego, CA (US)

(72) Inventors: Hesu HUANG, San Diego, CA (US); Dinesh RAMAKRISHNAN, Irvine, CA (US); Vidya ATHOTA, San Diego, CA (US); Ye JIANG, San Diego, CA (US); Jun WEI, Shenzhen (CN)

(21) Appl. No.: 19/588,169

(22) PCT Filed: Jan. 26, 2024
(86) PCT No.: PCT/CN2024/074169

§ 371 Date: May 15, 2026

(51) Int. Cl. G10L 17/06; G06F 21/32; G10L 17/02; G10L 17/20; G10L 21/0208; G10L 21/0216

(52) U.S. Cl. CPC G10L 17/06; G06F 21/32; G10L 17/02; G10L 17/20; G10L 21/0216; G10L 2021/02082

(57) ABSTRACT

Systems and techniques are provided for processing one or more audio samples. A process can include determining an audio playback path of a device is currently enabled to output sound. An audio sample obtained using a microphone of the device while the audio playback path is enabled can be detected, and includes a user voice signal and an echo signal corresponding to the output sound from the audio playback path. Audio information comprising at least one of a current volume level associated with the audio playback path, or echo cancellation information associated with an echo cancellation engine configured to process the audio sample can be determined. A verification threshold value for voice-based verification of the user voice signal can be determined based on the audio information. A user verification result can be generated based on comparing the verification threshold value and a confidence score determined based on the audio sample.

### FIELD

Aspects of the present disclosure generally relate to voice and/or speech recognition. In some implementations, examples are described for performing voice-based user verification using a dynamic confidence threshold during audio playback.

### BACKGROUND

Electronic devices such as smartphones, tablet computers, wearable electronic devices, smart TVs, and the like are becoming increasingly popular among consumers. These devices can provide voice and/or data communication functionalities over wireless or wired networks. In addition, such electronic devices can include other features that provide a variety of functions designed to enhance user convenience. Electronic devices can include a speech recognition function for receiving voice commands from a user. Such a function allows an electronic device to perform a function associated with a voice command (e.g., such as via a keyword) when the voice command from a user is received and recognized. For example, the electronic device may activate a voice assistant application, play an audio file, or take a picture in response to the voice command from the user.

Speech recognition can be implemented as an “always-on” function in electronic devices in order to maximize its utility. These always-on functions require always-on software and/or hardware resources, which in turn lead to always-on power usage. Mobile electronic devices, internet of things (IoT) devices, and the like are particularly sensitive to such always-on power demands as they reduce battery life and consume other finite resources of the system, such as processing capacity.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for processing one or more audio samples. According to at least one illustrative example, an apparatus configured to process audio data is provided. The apparatus includes one or more memories configured to store the audio data and one or more processors coupled to the one or more memories. The one or more processors are configured to and can: determine that an audio playback path of a device is currently enabled, wherein the audio playback path includes a speaker configured to output sound from the audio playback path; detect an audio sample obtained using a microphone included in the device while the audio playback path is enabled, the audio sample including a user voice signal and an echo signal corresponding to the output sound from the audio playback path; determine audio information comprising at least one of a current volume level associated with the audio playback path, or echo cancellation information associated with an echo cancellation engine configured to process the audio sample; determine a verification threshold value for voice-based verification of the user voice signal, wherein the verification threshold value is based on the audio information; and generate a user verification result based on a comparison between the verification threshold value and a confidence score determined based on the audio sample.

In another illustrative example, a processor-implemented method for processing audio data is provided, the processor-implemented method including: determining that an audio playback path of a device is currently enabled, wherein the audio playback path includes a speaker configured to output sound from the audio playback path; detecting an audio sample obtained using a microphone included in the device while the audio playback path is enabled, the audio sample including a user voice signal and an echo signal corresponding to the output sound from the audio playback path; determining audio information comprising at least one of a current volume level associated with the audio playback path, or echo cancellation information associated with an echo cancellation engine configured to process the audio sample; determining a verification threshold value for voice-based verification of the user voice signal, wherein the verification threshold value is based on the audio information; and generating a user verification result based on a comparison between the verification threshold value and a confidence score determined based on the audio sample.

In another illustrative example, a non-transitory computer-readable storage medium comprising instructions stored thereon which, when executed by at least one processor, causes the at least one processor to: determine that an audio playback path of a device is currently enabled, wherein the audio playback path includes a speaker configured to output sound from the audio playback path; detect an audio sample obtained using a microphone included in the device while the audio playback path is enabled, the audio sample including a user voice signal and an echo signal corresponding to the output sound from the audio playback path; determine audio information comprising at least one of a current volume level associated with the audio playback path, or echo cancellation information associated with an echo cancellation engine configured to process the audio sample; determine a verification threshold value for voice-based verification of the user voice signal, wherein the verification threshold value is based on the audio information; and generate a user verification result based on a comparison between the verification threshold value and a confidence score determined based on the audio sample.

In another illustrative example, an apparatus is provided. The apparatus includes: means for determining that an audio playback path of a device is currently enabled, wherein the audio playback path includes a speaker configured to output sound from the audio playback path; means for detecting an audio sample obtained using a microphone included in the device while the audio playback path is enabled, the audio sample including a user voice signal and an echo signal corresponding to the output sound from the audio playback path; means for determining audio information comprising at least one of a current volume level associated with the audio playback path, or echo cancellation information associated with an echo cancellation engine configured to process the audio sample; means for determining a verification threshold value for voice-based verification of the user voice signal, wherein the verification threshold value is based on the audio information; and means for generating a user verification result based on a comparison between the verification threshold value and a confidence score determined based on the audio sample.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof.

FIG. 1A is a block diagram illustrating an example speech recognition system, in accordance with some examples;

FIG. 1B is a block diagram illustrating components of a user computing device, in accordance with some examples;

FIG. 2 is a block diagram illustrating an example keyword detection system, in accordance with some examples;

FIG. 3 is a block diagram illustrating an example feature generator, in accordance with some examples;

FIG. 4 is a block diagram illustrating an example communication device including an echo cancellation and noise suppression (ECNS) engine, in accordance with some examples;

FIGS. 5A-5C are diagrams illustrating examples of neural networks, in accordance with some examples;

FIG. 6 is a block diagram illustrating an example of a deep convolutional network (DCN), in accordance with some examples;

FIG. 7 is a diagram illustrating an example of a voice activation system that can be used to implement dynamic adjustment of a user verification threshold based on playback volume and/or echo cancellation information associated with barge-in during audio playback, in accordance with some examples;

FIG. 8 is a flow chart illustrating an example of a process for processing one or more audio samples, in accordance with some examples; and

FIG. 9 is a block diagram illustrating an example of a computing system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Voice recognition generally refers to the discrimination of a human voice by an electronic device in order to perform some function. One type of voice recognition may include keyword detection (e.g., wake word detection). Keyword detection may refer to a technique where a device detects and responds to certain words. For example, many consumer electronic devices may use keyword detection to recognize specific key words to perform certain actions, such as to “wake” a device, to query a device, and/or to cause the device to perform various other functions. Voice recognition can also be used in more complex functionalities, such as “far field” voice recognition (e.g., from a mobile device placed across a room), user identity verification (e.g., by voice signature), voice recognition during other audio output (e.g., detecting a voice command while playing back music on a device or detecting an interrupting command while a smart assistant is speaking), and voice interaction in complex noise environments, such as within moving vehicles. These are just a few examples, and many others are possible.

Voice recognition, like various other processing tasks on electronic devices, requires power and dedicated hardware and/or software to function. Further, voice recognition may be implemented as an “always-on” function (e.g., where audio is continuously monitored for key word detection) to maximize its utility to users of electronic devices with voice recognition functionality. For devices that are plugged in, the power usage of always-on voice recognition functionality is primarily an efficiency consideration, but for power sensitive devices (e.g., battery powered devices, mobile electronic devices, IoT devices, and the like) with always-on voice recognition functionality, power usage may be of more concern. For example, power use from always-on functions can limit the run-time of such devices and reduce capacity for other system processing requirements.

Voice recognition can include voice activity detection. For example, voice activity detection can refer to the detection of a human voice by a computing device in order to perform some function. For instance, keyword detection (e.g., also referred to as keyword recognition and/or keyword spotting (KWS)) is a task of detecting one or more keyword in an audio signal (e.g., an audio signal including human speech or spoken words). For example, keyword detection can be used to distinguish an activation phrase or a specific command from other speech and noise in an audio signal. In some cases, keyword detection systems can target or be utilized by edge devices such as mobile phones and smart speakers. Detected keywords can include single words, compound words, phrases including multiple words, etc. In some cases, keyword detection can be performed based on a set of pre-determined keywords and/or a set of user-defined keywords. In some cases, user-defined keywords can include one or more adaptations, adjustments, etc., that are determined based on specific characteristics of a given user's voice or speech.

Keyword detection can be performed for one or more audio data inputs (e.g., also referred to herein as “audio data,” “audio signals,” and/or “audio samples”). For instance, an audio sample provided to a keyword detection system can be a streaming audio signal. In some examples, keyword detection can be performed for the streaming audio signal in real-time. A streaming audio signal can be recorded by or obtained from a microphone associated with a computing device. Keyword detection can be performed locally or remotely. For example, keyword detection can be performed locally using one or more processors of the same computing device that collects or obtains the streaming audio signal. In some examples, keyword detection can be performed remotely by transmitting the streaming audio signal (or a representation thereof) from the local computing device to a remote computing device (e.g., the local computing device records an audio signal but offloads keyword detection processing tasks to a remote computing device).

In some examples, a voice activation system can be included in or implemented in a consumer electronic device to activate the device and/or one or more functions provided by the device. For instance, a voice activation system can be used to wake a consumer electronic device based on a target user (e.g., registered user) uttering a keyword to wake up the device. In some examples, a voice activation system can include a keyword detection sub-system (e.g., configured to detect that an expected or configured keyword is the word uttered by the user) and can include a user voice verification (also referred to as “user verification”) sub-system. For example, the user voice verification sub-system can detect that an utterance is spoken by a user and not an individual other than the user.

A consumer electronic device (e.g., a smartphone, an AR device, a wearable device, etc.) can include a voice activation system and may further include one or more audio output components, such as speakers or other output audio transducers. When voice activation is performed during audio playback by the same device (e.g., when voice activation is performed concurrent with audio playback on a speaker of the same device, etc.), “barge-in” may occur. As used herein, “barge-in” or “barge-in during audio playback” can refer to voice activation and/or voice verification that is performed with audio playback concurrency on the same device (e.g., a user is uttering a word or phrase for voice activation if a device as audio is played back through a speaker of the same device). For instance, when barge-in occurs, the audio input to the voice activation system (e.g., captured using a microphone of the device) may include both the user utterance and an echo signal corresponding to the audio playback concurrency on the same device.

In some cases, echo cancellation (e.g., including echo cancellation and noise suppression (ECNS)) can be used to process the microphone audio data prior to performing voice activation and/or voice-based user verification based on the processed microphone signal. For example, during barge-in, echo cancellation may be performed to remove or suppress from the captured microphone signal at least a portion of an echo corresponding to the concurrent audio playback on the same device.

In many examples, an echo residual remains in the microphone signal even after applying echo cancellation and/or suppression. The echo residual may be associated with distortion to near-end speech after the echo cancellation processing is performed. For example, the microphone signal after applying echo cancellation can include an echo residual and can include distortion to near-end speech (e.g., distortion of the user utterance represented in the audio samples). The presence of an echo residual in the input audio to a voice verification system can be associated with degraded performance and accuracy of the voice verification system. In some cases, voice-based user verification may experience a relatively greater performance degradation than keyword detection when an echo residual is present in the microphone audio data provided as input to a voice verification system that implements the user verification and keyword detection. For example, voice-based user verification techniques may be more sensitive to the noise and/or distortion from the echo residual.

There is a need for systems and techniques that can be used to perform voice-based user verification based on audio signals or samples (e.g., captured by a microphone) that may or may not include an echo residual. There is a further need for systems and techniques that can be used to perform voice-based user verification during barge-in associated with audio playback concurrency.

Systems, apparatuses, methods (also referred to as processes), and computer-readable media (collectively referred to herein as “systems and techniques”) are described herein for voice-based user verification that can be implemented based on one or more dynamic (e.g., adjustable) thresholds for verification. For example, the one or more dynamic thresholds for verification can be dynamic threshold values corresponding to verifying or not verifying an utterance as being spoken by a particular (e.g., registered, configured, etc.) user. In some aspects, the dynamic threshold value can be implemented as a dynamic confidence level value for voice-based user verification by a user-specific voice model. In some examples, the dynamic threshold value can be implemented as a dynamic adjustment to a static or default confidence level value for verification by the user-specific voice model.

For example, the static or default confidence level value may be utilized when voice activation and/or voice-based user verification is performed without barge-in (e.g., without audio playback concurrency on the same device). Different dynamic adjustments and/or different dynamic thresholds can be utilized to perform voice activation and/or voice-based user verification when barge-in occurs or is present in the input audio samples captured by a microphone. For example, the dynamic adjustment to the verification threshold used by a voice verification engine can be based on the output volume of the concurrent audio playback associated with the barge-in. A higher output volume of the audio playback can correspond to a larger echo residual and/or distortion of the user utterance represented in the audio samples captured by the microphone, and a lower output volume of the audio playback can correspond to a smaller echo residual and/or distortion of the user utterance.

In some examples, a larger adjustment can be applied to the verification threshold based on a relatively high output volume of the concurrent audio playback, and a smaller adjustment (or no adjustment) may be applied to the verification threshold based on a relatively low output volume of the concurrent audio playback. For example, the output volume of an audio playback device may be a volume level selected from a plurality of configured (e.g., pre-defined) volume levels. In some cases, a relatively high volume level can be a volume level above a threshold (e.g., upper quartile, upper half, etc., of the plurality of configured volume levels). A relatively low volume level can be a volume level below a threshold (e.g., lower quartile, lower half, etc., of the plurality of configured volume levels). The same threshold, or a different threshold, can be used for determining relatively high volume levels and relatively low volume levels. In some examples, a relatively high output volume can correspond to an output volume that is greater than a threshold volume value (e.g., a threshold volume value in percentage of maximum output volume of the audio playback device or apparatus, in absolute or decibel value, in quantized or discrete levels of volume, etc.), and a relatively low output volume can correspond to an output volume that is less than the threshold volume value. A larger adjustment to the verification threshold can correspond to a lower adjusted value (e.g., also referred to as a dynamic value) of the confidence level used to perform voice-based user verification. A smaller adjustment to the verification threshold can correspond to a higher confidence level being used to perform the voice-based user verification. For instance, the adjusted confidence level can be determined as a baseline or configured confidence level value minus the dynamic adjustment.

In some examples, a pre-determined or configured mapping between different audio output volume levels and a corresponding threshold adjustment value (e.g., threshold offset) can be used to calculate and apply the dynamically adjusted confidence level for performing voice-based user verification.

In some examples, the systems and techniques can dynamically determine an adjusted confidence level (e.g., threshold) for voice-based user verification during barge-in associated with audio playback concurrency. For example, echo cancellation information can be obtained from an echo cancellation engine that processes audio samples obtained from a microphone, and the echo cancellation information can be used to determine the adjusted confidence level threshold. In some aspects, the echo cancellation information can be indicative of the echo residual included in the audio sample(s) provided from the echo cancellation engine to a voice activation engine and/or a voice-based user verification engine. In some examples, the echo cancellation information can be indicative of one or more of a signal-to-noise-ratio (SNR), a signal-to-echo-ratio (SER), and/or an echo-return-loss-enhancement (ERLE) associated with the echo cancellation performed by the echo cancellation engine. For example, the echo cancellation information can be indicative of an SNR, SER, and/or ERLE, etc., associated with an echo residual included in the audio sample(s) provided as input to a voice-based user verification engine. In some cases, the echo cancellation information may be indicative of an SNR, SER, and/or ERLE, etc., associated with the echo-canceled audio samples that are output by the echo cancellation engine and provided as input to the voice-based user verification engine.

Further aspects of the systems and techniques will be described with respect to the figures.

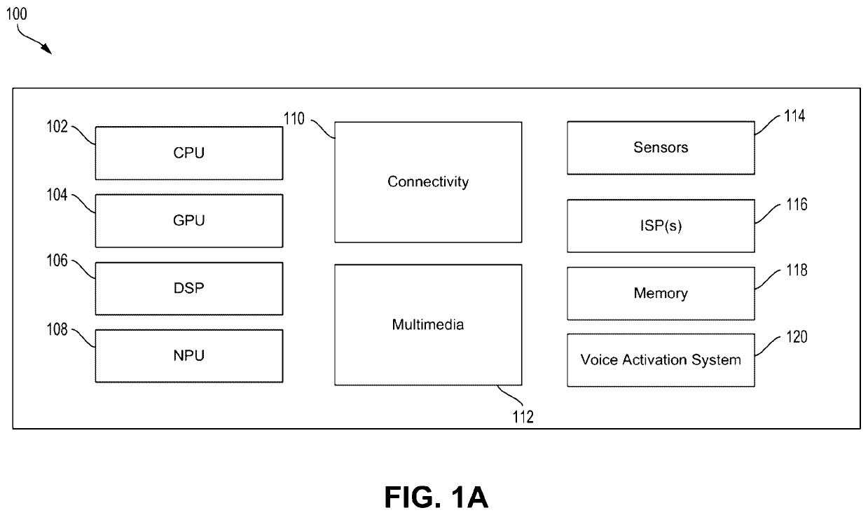

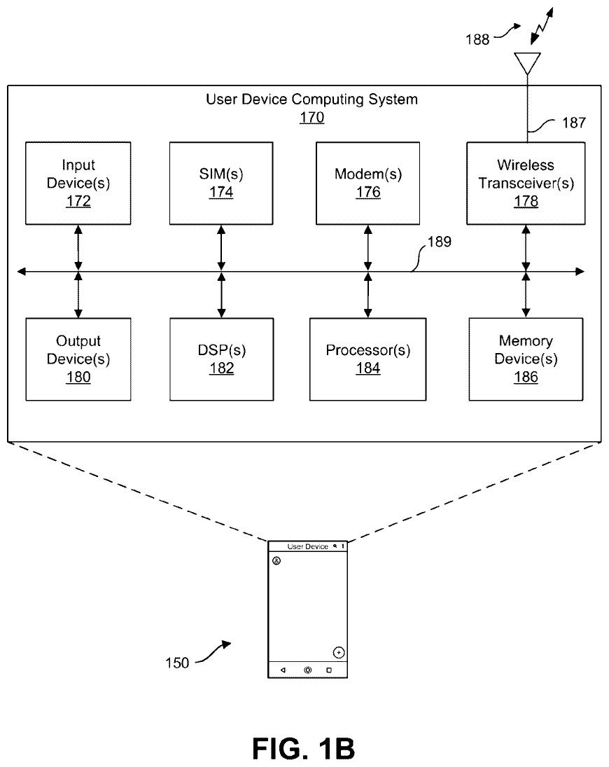

FIG. 1A illustrates an example implementation of a system-on-a-chip (SoC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SoC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures, speech, and/or other interactive user action(s) or input(s). In one implementation, the NPU 108 is implemented in the CPU 102, DSP 106, and/or GPU 104. The SoC 100 may also include a sensor processor 114, image signal processors (ISPs) 116, and/or a voice activation system 120. In some examples, the sensor processor 114 can be associated with or connected to one or more sensors for providing sensor input(s) to sensor processor 114. For example, the one or more sensors and the sensor processor 114 can be provided in, coupled to, or otherwise associated with a same computing device.

In some examples, the one or more sensors can include one or more microphones for receiving sound (e.g., an audio input), including sound or audio inputs that can be used to perform voice activation, voice-based user verification, keyword detection, etc. In some cases, the sound or audio input received by the one or more microphones (and/or other sensors) may be digitized into data packets for analysis and/or transmission. The audio input may include ambient sounds in the vicinity of a computing device associated with the SoC 100 and/or may include speech from a user of the computing device associated with the SoC 100. In some cases, a computing device associated with the SoC 100 can additionally, or alternatively, be communicatively coupled to one or more peripheral devices (not shown) and/or configured to communicate with one or more remote computing devices or external resources, for example using a wireless transceiver and a communication network, such as a cellular communication network.

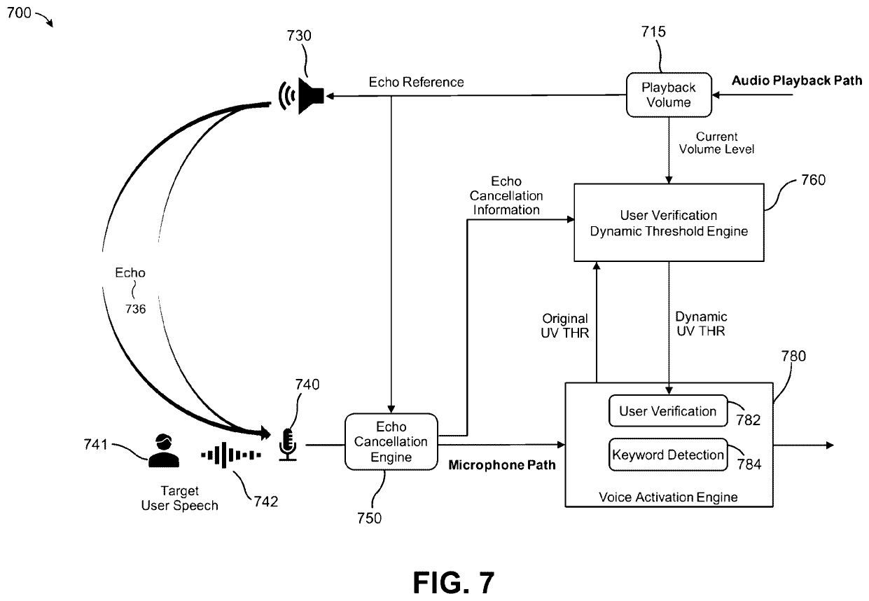

SoC 100, DSP 106, NPU 108 and/or voice activation system 120 may be configured to perform audio signal processing. For example, the voice activation system 120 may be configured to perform audio signal processing for voice activation of a device including the SoC 100 and/or including the voice activation system 120. In some examples, the voice activation system 120 of FIG. 1A can include a user verification engine and a keyword detection engine. For instance, the user verification engine can be used by the voice activation system 120 to verify, authenticate, confirm, etc., that speech or other utterances in an input audio sample were spoken by a particular user. The keyword detection engine can be used to detect a particular utterance or keyword spoken within the input audio sample. In some cases, the keyword detection engine and/or voice activation system 120 can be configured to perform steps for keyword spotting (KWS). One or more portions of the steps, such as feature generation for processing the input audio sample against a user voice model or machine learning network and/or for processing the input audio sample for KWS, may be performed by the voice activation system 120 while the DSP 106/NPU 108 performs other steps, such as steps using one or more machine learning networks and/or machine learning techniques according to aspects of the present disclosure and as described herein. In some cases, the voice activation system 120 of FIG. 1A can be the same as or similar to the voice activation engine 780 of FIG. 7.

FIG. 1B illustrates an example of a computing system 170 of a wireless device 150. The wireless device 150 may include a client device such as a user equipment (UE) or other type of device (e.g., a station (STA) configured to communication using a Wi-Fi interface) that may be used by an end-user. For example, the wireless device 150 may include a mobile phone, router, tablet computer, laptop computer, tracking device, wearable device (e.g., a smart watch, glasses, an extended reality (XR) device such as a virtual reality (VR), augmented reality (AR), or mixed reality (MR) device, etc.), Internet of Things (IoT) device, a vehicle, an aircraft, and/or another device that is configured to communicate over a wireless communications network. The computing system 170 includes software and hardware components that may be electrically or communicatively coupled via a bus 189 (e.g., or may otherwise be in communication, as appropriate). For example, the computing system 170 includes one or more processors 184. The one or more processors 184 may include one or more CPUs, ASICs, FPGAs, APs, GPUs, VPUs, NSPs, microcontrollers, dedicated hardware, any combination thereof, and/or other processing device or system. The bus 189 may be used by the one or more processors 184 to communicate between cores and/or with the one or more memory devices 186.

The computing system 170 may also include one or more memory devices 186, one or more digital signal processors (DSPs) 182, one or more SIMs 174, one or more modems 176, one or more wireless transceivers 178, an antenna 187, one or more input devices 172 (e.g., a camera, a mouse, a keyboard, a touch sensitive screen, a touch pad, a keypad, a microphone, and/or the like), and one or more output devices 180 (e.g., a display, a speaker, a printer, and/or the like).

In some aspects, computing system 170 may include one or more radio frequency (RF) interfaces configured to transmit and/or receive RF signals. In some examples, an RF interface may include components such as modem(s) 176, wireless transceiver(s) 178, and/or antennas 187. The one or more wireless transceivers 178 may transmit and receive wireless signals (e.g., signal 188) via antenna 187 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the computing system 170 may include multiple antennas or an antenna array that may facilitate simultaneous transmit and receive functionality. Antenna 187 may be an omnidirectional antenna such that radio frequency (RF) signals may be received from and transmitted in all directions. The wireless signal 188 may be transmitted via a wireless network. The wireless network may be any wireless network, such as a cellular or telecommunications network (e.g., 3G, 1G, 5G, etc.), wireless local area network (e.g., a Wi-Fi network), a Bluetooth™ network, and/or other network.

In some examples, the wireless signal 188 may be transmitted directly to other wireless devices using sidelink communications (e.g., using a PC5 interface, using a DSRC interface, etc.). Wireless transceivers 178 may be configured to transmit RF signals for performing sidelink communications via antenna 187 in accordance with one or more transmit power parameters that may be associated with one or more regulation modes. Wireless transceivers 178 may also be configured to receive sidelink communication signals having different signal parameters from other wireless devices.

In some examples, the one or more wireless transceivers 178 may include an RF front end including one or more components, such as an amplifier, a mixer (e.g., also referred to as a signal multiplier) for signal down conversion, a frequency synthesizer (e.g., also referred to as an oscillator) that provides signals to the mixer, a baseband filter, an analog-to-digital converter (ADC), one or more power amplifiers, among other components. The RF front-end may generally handle selection and conversion of the wireless signals 188 into a baseband or intermediate frequency and may convert the RF signals to the digital domain.

In some cases, the computing system 170 may include a coding-decoding device (or CODEC) configured to encode and/or decode data transmitted and/or received using the one or more wireless transceivers 178. In some cases, the computing system 170 may include an encryption-decryption device or component configured to encrypt and/or decrypt data (e.g., according to the AES and/or DES standard) transmitted and/or received by the one or more wireless transceivers 178.

The one or more SIMs 174 may each securely store an international mobile subscriber identity (IMSI) number and related key assigned to the user of the wireless device 150. The IMSI and key may be used to identify and authenticate the subscriber when accessing a network provided by a network service provider or operator associated with the one or more SIMs 174. The one or more modems 176 may modulate one or more signals to encode information for transmission using the one or more wireless transceivers 178. The one or more modems 176 may also demodulate signals received by the one or more wireless transceivers 178 in order to decode the transmitted information. In some examples, the one or more modems 176 may include a Wi-Fi modem, a 1G (or LTE) modem, a 5G (or NR) modem, and/or other types of modems. The one or more modems 176 and the one or more wireless transceivers 178 may be used for communicating data for the one or more SIMs 174.

The computing system 170 may also include (and/or be in communication with) one or more non-transitory machine-readable storage media or storage devices (e.g., one or more memory devices 186), which may include, without limitation, local and/or network accessible storage, a disk drive, a drive array, an optical storage device, a solid-state storage device such as a RAM and/or a ROM, which may be programmable, flash-updateable, and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 186 and executed by the one or more processor(s) 184 and/or the one or more DSPs 182. The computing system 170 may also include software elements (e.g., located within the one or more memory devices 186), including, for example, an operating system, device drivers, executable libraries, and/or other code, such as one or more application programs, which may comprise computer programs implementing the functions provided by various aspects, and/or may be designed to implement methods and/or configure systems, as described herein.

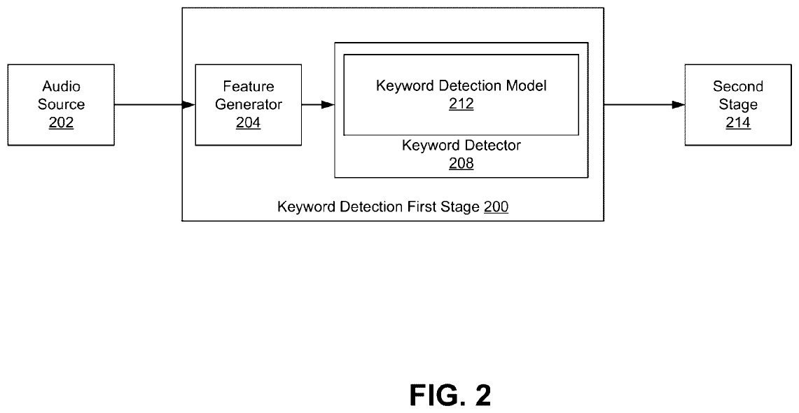

FIG. 2 depicts an example keyword detection first stage 200, in accordance with aspects of the present disclosure. Keyword detection first stage 200 receives audio signals (e.g., pulse-code modulation (PCM) audio data from an analog microphone, pulse density modulation (PDM) high definition audio from a digital microphone, and the like) from an audio source 202 in an electronic system. For example, the audio signals could be generated by one or more microphones of an electronic device, such as a mobile electronic device, smart home device, internet of things (IoT) device, or other edge processing device. In some cases, the audio signal may be received substantially in real time.

In some cases, certain devices, such as relatively low-power (e.g., battery operated) devices may include a two-stage speech recognition system wherein a first keyword detection stage (e.g., the first keyword detection stage 200) generates a keyword detection output that may be used to activate a second keyword detection stage (e.g., second keyword detection stage 214). In multiple stage keyword detection, one or more stages can implement a low complexity and low latency keyword detection model and one or more subsequent stages can implement a higher complexity keyword detection model. For instance, a model associated with the first keyword detection stage 200 can be a low complexity and low latency keyword detection model. Based on the first stage 200 generating a keyword detection output (e.g., a keyword detection output having a detection score greater than or equal to a first threshold), a model associated with the second keyword detection stage 214 can be activated and used to process the same audio sample (e.g., the same audio sample that triggered the detection output of the first stage 200). The relatively high complexity and/or more performant second stage keyword detection model can be used to provide a double confirmation of a keyword detection (e.g., by validating or confirming the keyword detection of the first stage) or to reject the first stage keyword detection as a false positive (e.g., invalidating the keyword detection of the first stage).

In some cases, the keyword detection first stage 200 may be implemented using a relatively lower-powered circuit such as a DSP, codec circuit, etc. When a keyword is detected, a second stage 214 may be activated which may, for example, handle more complex tasks, such as more freeform word recognition, detecting commands, performing tasks, etc. In some cases, the second stage may be performed on a relatively higher-powered circuit, such as a processor, GPU, ML/AI processor, etc.

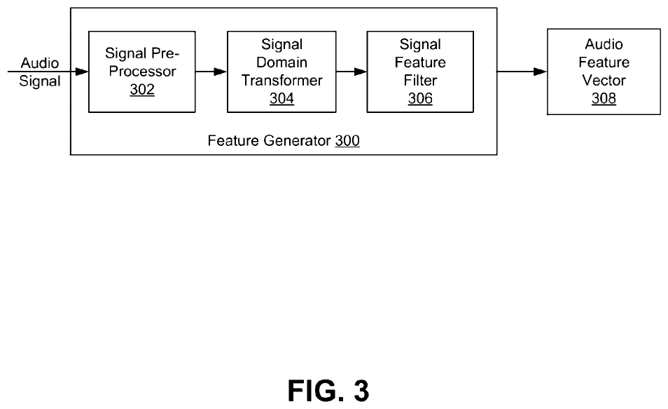

As illustrated in FIG. 2, received audio samples (e.g., audio samples from audio source 202) are processed by a feature generator 204 of the keyword detection first stage 200. Feature generator 204 may be, for example, a hardware-implemented Fourier transformation, such as a fast Fourier transformation (FFT) function or circuit. A Fourier transform is generally a function for deconstructing a time domain representation of a signal, such as the received audio signals, into a frequency domain representation. The frequency domain representation may include voltages or powers present at varying frequencies in the received audio signals. In some cases, the feature generator 204 may generate a set of features, such as a feature vector, based on these representations. This set of features may be output to a keyword detector 208. An example of feature generator 204 is described in more detail with respect to FIG. 3. Notably, other or additional forms of feature generation may be used in other aspects and examples.

Keyword detector 208 may use a keyword detection model 212 to determine whether the received audio signal includes portions of a keyword. In some cases, the keyword detector 208 may accept, as input, tens to hundreds of audio frames per second and the keyword detector 208 may attempt to detect parts of the keyword in an audio signal. In some cases, the keyword detection model 212 of keyword detector 208 may be a part of a multi-stage speech recognition system.

After the keyword detector 208 determines that a keyword was detected in the received audio signal, the keyword detector 208 generates a signal for a second stage 214. For example, a detected keyword may cause an application to launch, or another part of the electronic device to wake up (e.g., a screen, other processor, or other sensor), a query to be run locally or at a remote data service, additional speech recognition processing, and the like. In some aspects, the second stage 214 may receive an indication that keyword has been detected, while in other aspects and/or examples, second stage 214 may receive additional information, such as information specific to the detected keyword, such as one or more detected keywords in the voice activity. Notably, there may be additional functions (not shown) between keyword detector 208 and second stage 214, such as additional stages of keyword detection or analysis.

FIG. 3 depicts an example of a feature generator 300, such as feature generator 204 of FIG. 2, in accordance with aspects of the present disclosure. It should be understood that many techniques may be used to generate feature vectors for an audio and that feature generator 300 is just a single example of a technique that may be used to generate feature vectors.

Feature generator 300 receives an audio signal at signal pre-processor 302. As above, the audio signal may be from an audio source, such as audio source 202, of an electronic device, such a microphone.

Signal pre-processor 302 may perform various pre-processing steps on the received audio signal. For example, signal pre-processor 302 may split the audio signal into parallel audio signals and delay one of the signals by a predetermined amount of time to prepare the audio signals for input into an FFT circuit.

As another example, signal pre-processor 302 may perform a windowing function, such as a Hamming, Hann, Blackman-Harris, Kaiser-Bessel window function, or other sine-based window function, which may improve the performance of further processing stages, such as signal domain transformer 304. Generally, a windowing (or window) function in may be used to reduce the amplitude of discontinuities at the boundaries of each finite sequence of received audio signal data to improve further processing.

As another example, signal pre-processor 302 may convert the audio signal data from parallel to serial, or vice versa, for further processing. The pre-processed audio signal from the signal pre-processor 302 may be provided to signal domain transformer 304, which may transform the pre-processed audio signal from a first domain into a second domain, such as from a time domain into a frequency domain.

In some aspects, signal domain transformer 304 implements a Fourier transform, such as a fast Fourier transform (FFT). For example, in some cases, the fast Fourier transform may be a 16-band (or bin, channel, or point) FFT, which generates a compact feature set that may be efficiency processed by a model. In some cases, a Fourier transform provides fine spectral domain information about the incoming audio signal as compared to conventional single channel processing, such as conventional hardware SNR threshold detection. The result of signal domain transformer 304 is a set of audio features, such as a set of voltages, powers, or energies per frequency band in the transformed data.

The set of audio features may then be provided to signal feature filter 306, which may reduce the size of or compress the feature set in the audio feature data. In some aspects, signal feature filter 306 may discard certain features from the audio feature set, such as symmetric or redundant features from multiple bands of a multi-band FFT. Discarding this data reduces the overall size of the data stream for further processing and may be referred to a compressing the data stream.

For example, in some cases, a 16-band FFT may include 8 symmetric or redundant bands of after the powers are squared because audio signals are real. Thus, signal feature filter 306 may filter out the redundant or symmetric band information and output an audio feature vector 308. In some cases, output of the signal feature filter may be compressed or otherwise processed prior to output as the audio feature vector 308. The audio feature vector 308 may be provided to a keyword detector for processing by a keyword detection model, such as keyword detector 208 and keyword detection model 212 as shown in FIG. 2.

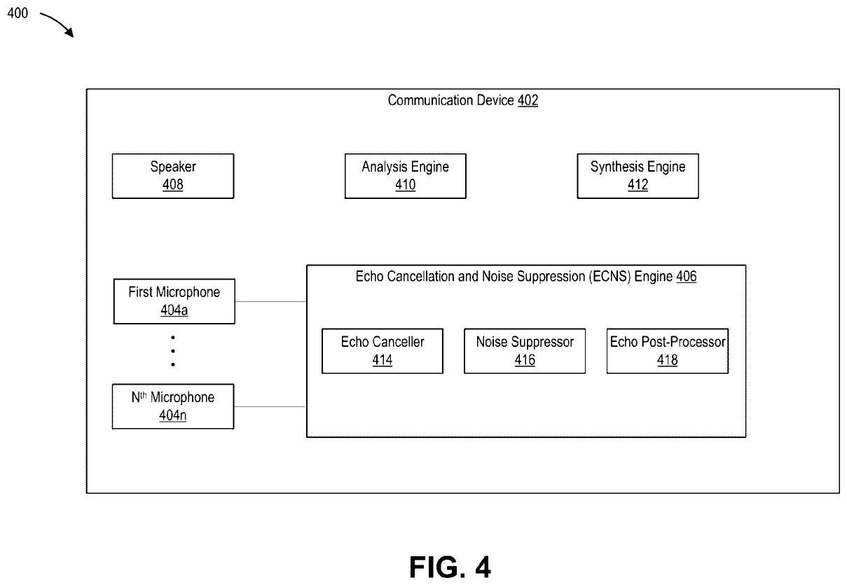

FIG. 4 is a block diagram illustrating an example communication device 402 that includes an echo cancellation and noise suppression (ECNS) engine 406. In some examples, the ECNS engine 406 can be an integrated ECNS engine (also referred to as an “ECNS module”) of the communication device 402. For instance, the ECNS engine 406 can be included in and/or implemented by a DSP or other audio processing engine and/or audio processor of the communication device 402. In some aspects, the communication device 402 can be the same as or similar to a device implementing the example speech recognition system 100 of FIG. 1A and/or example computing system 170 of the wireless device (e.g., UE) 150 of FIG. 1B.

The communication device 402 may include N microphones 404a, . . . , 404n that receive sound input from one or more sources (e.g., a loudspeaker 408, background noise, echo/echoes from a speaker/speakers (stereo/surround sound), etc.). Each of the microphones 404a, . . . , 404n may produce a signal or channel of audio that may be slightly different than one another. In one configuration, there may be two microphones 404 (e.g., first microphone 404a and N^{th} microphone 404n, where N=2) that produce two channels of audio, although any number of microphones and/or channels may be used. For instance, in another example, there may be four microphones 404 (e.g., first microphone 404a, . . . , and N^{th} microphone 404n, where N=4) that produce four channels of audio, etc.

The microphones 404a-n and speaker 408 may use additional modules to process acoustic signals into digital audio and vice versa. For example, the communication device 402 may include analog-to-digital converters, digital-to-analog converters, audio buffers, an automatic volume control module, etc. The communication device 402 may also include more than one speaker 408. As used herein, the term “communication device” can be used to refer to an electronic device that may be used to receive, externally play, and/or optimize audio to and from a user. Examples of communication devices include telephones, speaker phones, cellular phones, personal digital assistants (PDAs), handheld devices, wireless modems, laptop computers, personal computers, etc. A communication device 402 may alternatively be referred to as an access terminal, a mobile terminal, a mobile station, a remote station, a user terminal, a terminal, a subscriber unit, a subscriber station, a mobile device, a wireless device, user equipment (UE) or some other similar terminology.

The communication device 402 may also include an analysis engine 410 and a synthesis engine 412 configured to deconstruct and reconstruct audio signals, respectively. This may allow other modules discussed herein to process the audio (e.g., perform echo cancellation and noise suppression, etc.). The analysis engine 410 and synthesis engine 412 may refer to finite impulse response filter (FIR) banks that decompose a wideband signal into sub-bands and reconstructs the sub-bands into a single band, respectively.

Echo cancellation (EC) and multi-microphone noise suppression (NS) techniques, such as beamforming or masking, may be two distinct signal processing concepts, however their goals may converge with regard to acoustic echoes. Specifically, linear echo cancellation may subtract an echo estimate from the desired signal based on reference information, while noise suppression may blindly remove undesired interference (e.g., echoes) within a microphone signal using spatial filtering. Therefore, the communication device 402 may include an integrated echo cancellation and noise suppression module (e.g., ECNS engine 406) with an echo canceller (EC) 414, a noise suppressor (NS) 416, and an echo post-processor 418. In some aspects, the echo canceller 414 can be a linear echo canceller (LEC). In some cases, the ECNS engine 406 can be configured as a multi-channel ECNS engine.

In one illustrative example, the ECNS engine 406 can be implemented as a machine learning-based ECNS engine, for instance using one or more deep-learning machine learning networks or models, using one or more neural networks, etc.

In some examples, the echo canceller 414 may perform linear echo cancellation for selected frequencies for the signals received from the microphones 404a-n. In one configuration, the linear echo of the full band of frequencies received from the primary microphone 404a is cancelled while LEC is performed for only a set of low-band frequencies for secondary (e.g., non-primary) microphones 404b-n. The frequencies selected for LEC on the secondary channels may correspond to the range of frequencies over which spatial processing in the noise suppressor 416 is effective. In some cases, the “primary microphone” may refer to the microphone 404a closest to a user's mouth, where non-primary microphones may be considered secondary microphones 404b-n.

The noise suppressor 416 may perform spatial processing and/or noise suppression post-processing based on a noise reference from a spatial processor. For instance, the noise suppressor 416 may attenuate the echo as undesired interference based on spatial filtering. The echo post-processor 418 may perform non-linear echo post-processing by attenuating the non-linear echoes. The echo post-processor 418 may also perform non-linear echo clipping and comfort noise injection. In some cases, the echo post-processor 418 may include an echo notch masking module configured to reduce echo in a noise-suppressed signal from the noise suppressor 416. The echo notch masking module may perform amplitude suppression based on an echo direction of arrival (DOA) and speech likelihood information. Using the speech likelihood information, frequency bins with a high-likelihood for an echo direction of arrival (DOA) can be suppressed.

Occasionally, adaptive spatial processing used by a noise suppressor 416 adds echo from the secondary microphone 404b to the primary microphone 404a, and the echo post-processor 418 may be blind to the echo addition. Since the echo post-processor 418 is blind to the added echo, the echo post-processor 418 may not be able to cancel the added echo. The residual or added echo may be perceivable to the listener and can be distracting and/or undesirable, such as in voice call scenarios where there is otherwise little or no echo in the primary microphone 404a signal to begin with. In some examples, the echo post-processor 418 can be provided with additional information that may be used with a non-linear echo model to cancel the residual echo. In one configuration, a spatial-processed echo estimate may be determined by a supplemental spatial processor. The spatial processing performed by the supplemental spatial processor on the echo estimate(s) from the linear echo canceller 414 may replicate the processing performed on linear echo-cleaned outputs by the noise suppressor 416. This may make the echo post-processor 418 aware of the spatial processing of the echo canceller 414 outputs (by the noise suppressor 416) so that the echo post-processor 418 does not add any echo in the primary microphone 404a. Alternatively, or additionally, an echo estimate from a primary microphone 404a and at least one secondary microphone 404b may be used by the echo post-processor 418 to cancel non-linear echo. In some cases, a selector may select the echo estimate that is provided to the echo post-processor 418. In one configuration, the selector may select one of the primary microphone echo estimate, the secondary microphone echo estimate(s), or the spatial-processed echo estimate. The selector may scale the selected echo estimate. The selector may also select a combination of the primary microphone echo estimate, the secondary microphone echo estimate(s), or the spatial-processed echo estimate. In some cases, the selector is included in the echo post-processor 418. In another configuration, the selector may be located outside the echo post-processor 418.

Machine learning (ML) can be considered a subset of artificial intelligence (AI). ML systems can include algorithms and statistical models that computer systems can use to perform various tasks by relying on patterns and inference, without the use of explicit instructions. One example of a ML system is a neural network (also referred to as an artificial neural network), which may include an interconnected group of artificial neurons (e.g., neuron models). Neural networks may be used for various applications and/or devices, such as speech analysis, audio signal analysis, image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding this output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning (DL) is one example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases. Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

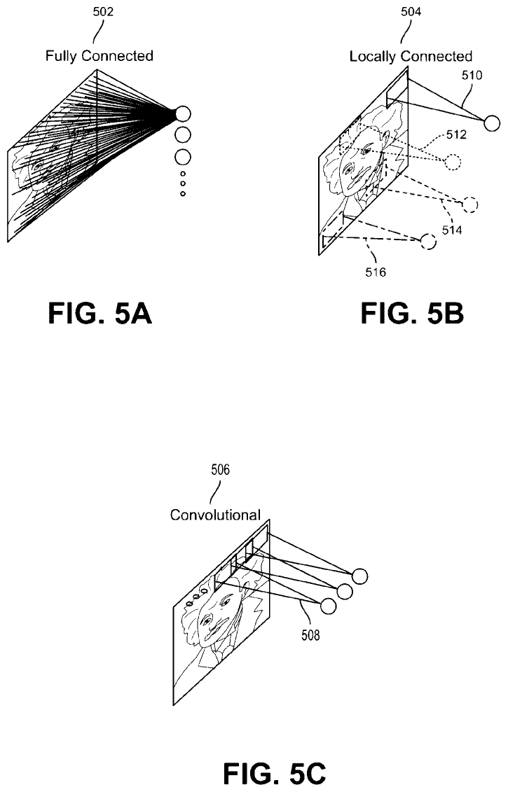

FIGS. 5A-5C illustrate example neural networks which may be used for voice activation, voice-based user verification, keyword detection, echo cancellation and/or noise suppression, etc., in accordance with aspects of the present disclosure. Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

In some cases, the connections between layers of a neural network may be fully connected or locally connected. FIG. 5A illustrates an example of a fully connected neural network 502. In a fully connected neural network 502, a neuron in a first layer may communicate its output to every neuron in a second layer, so that each neuron in the second layer will receive input from every neuron in the first layer. FIG. 5B illustrates an example of a locally connected neural network 504. In a locally connected neural network 504, a neuron in a first layer may be connected to a limited number of neurons in the second layer. More generally, a locally connected layer of the locally connected neural network 504 may be configured so that each neuron in a layer will have the same or a similar connectivity pattern, but with connections strengths that may have different values (e.g., 510, 512, 514, and 516). The locally connected connectivity pattern may give rise to spatially distinct receptive fields in a higher layer, as the higher layer neurons in a given region may receive inputs that are tuned through training to the properties of a restricted portion of the total input to the network.

One example of a locally connected neural network is a convolutional neural network. FIG. 5C illustrates an example of a convolutional neural network 506. The convolutional neural network 506 may be configured such that the connection strengths associated with the inputs for each neuron in the second layer are shared (e.g., 508). Convolutional neural networks may be well suited to problems in which the spatial location of inputs is meaningful.

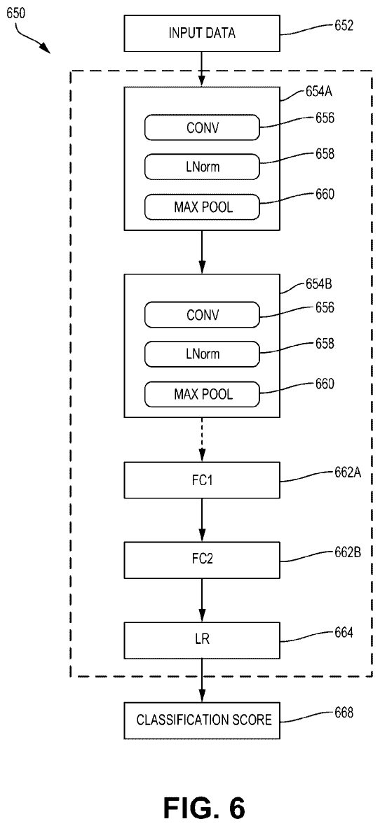

FIG. 6 is a block diagram illustrating an example of a deep convolutional network (DCN) 650, in accordance with aspects of the present disclosure. The DCN 650 may include multiple different types of layers based on connectivity and weight sharing. As shown in FIG. 6, the DCN 650 includes the convolution blocks 654A, 654B. Each of the convolution blocks 654A, 654B may be configured with a convolution layer (CONV) 656, a normalization layer (LNorm) 658, and a max pooling layer (MAX POOL) 660.

The convolution layers 656 may include one or more convolutional filters, which may be applied to the input data 652 to generate a feature map. Although only two convolution blocks 654A, 654B are shown, the present disclosure is not so limiting, and instead, any number of convolution blocks (e.g., blocks 654A, 654B) may be included in the DCN 650 according to design preference. The normalization layer 658 may normalize the output of the convolution filters. For example, the normalization layer 658 may provide whitening or lateral inhibition. The max pooling layer 660 may provide down sampling aggregation over space for local invariance and dimensionality reduction.

The parallel filter banks, for example, of a deep convolutional network may be loaded on a CPU 102 or GPU 104 of an SOC 100 to achieve high performance and low power consumption. In some examples, the parallel filter banks may be loaded on the DSP 106 or an ISP 116 of an SOC 100. In addition, the DCN 650 may access other processing blocks that may be present on the SOC 100, such as sensor processor 114 and voice activation system 120, dedicated, respectively, to sensors and voice activation processing.

The deep convolutional network 650 may also include one or more fully connected layers, such as layer 662A (labeled “FC1”) and layer 662B (labeled “FC2”). The DCN 650 may further include a logistic regression (LR) layer 664. Between each layer 656, 658, 660, 662A, 662B, 664 of the DCN 650 are weights (not shown) that are to be updated. The output of each of the layers (e.g., 656, 658, 660, 662A, 662B, 664) may serve as an input of a succeeding one of the layers (e.g., 656, 658, 660, 662A, 662B, 664) in the deep convolutional network 650 to learn hierarchical feature representations from input data 652 (e.g., images, audio, video, sensor data and/or other input data) supplied at the first of the convolution blocks 654A.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new input and a forward pass through the network may yield an output 422 that may be considered an inference or a prediction of the DCN.

The output of the DCN 650 is a classification score 668 for the input data 652. The classification score 668 may be a probability, or a set of probabilities, where the probability is the probability of the input data including a feature from a set of features the DCN 650 is trained to detect.

As noted previously, systems and techniques are described herein that can be used to perform voice-based user verification based on one or more dynamic confidence level thresholds for verification (e.g., verification that an utterance or other input speech represented in an audio sample was spoken by an expected, configured, registered, etc., user). In some aspects, the systems and techniques can be used to perform voice-based user verification with increased accuracy during barge-in associated with audio playback concurrency on a device implementing the voice-based verification system, based on decreasing the confidence level threshold for user verification during barge-in.

FIG. 7 is a diagram illustrating an example of a voice activation system 700 that can be used to implement dynamic adjustment of a user verification threshold based on playback volume and/or echo cancellation information associated with barge-in during audio playback, in accordance with some examples. In some aspects, the voice activation system 700 can be the same as or similar to the voice activation system 120 of FIG. 1A and/or can be implemented by the user device computing system 170 or component thereof (e.g., DSP 182, etc.) shown in FIG. 1B.

A device implementing the voice activation system 700 can include an audio playback path (e.g., shown at the top of FIG. 7) and a microphone path (e.g., shown at the bottom of FIG. 7). For example, the audio playback path can be associated with the output (e.g., playback) of one or more audio signals using a speaker 730 included in the device.

An output volume or output volume level of the audio playback by the speaker 730 can be configured automatically, can be configured by a user, or can be configured based on a combination of the two. In one illustrative example, the audio playback volume 715 can be associated with playback volume information (e.g., “Current Volume Level” of FIG. 7) for sound that is output by the speaker 730. In some aspects, the audio playback volume 715 and/or the playback volume information for the audio playback path can be obtained from one or more application programming interfaces (APIs) and/or an operating system (OS) associated with the device used to implement the voice activation system 700.

For example, the audio playback volume 715 can be obtained or determined based on querying a corresponding API of the device for the currently existing volume level set on the device. In some aspects, the current volume level 715 set for the device can be based on user inputs to increase or decrease the device's volume level (e.g., user selection of a volume up button or a volume down button, etc.). The current volume level can be stored in memory and/or cached by the device implementing voice activation system 700, and can be accessed at block 715 by the voice activation system 700.

In one illustrative example, the determination of the current volume level using the playback volume block 715 can be triggered or performed based on an identification of barge-in (e.g., receiving a user utterance 742 by microphone 740 concurrently with audio playback by the speaker 730). For example, the identification of barge-in can be based on the audio playback path and the microphone path of FIG. 7 being active at the same time (e.g., based on concurrency of audio data Tx on the audio playback path and audio data Rx on the microphone path).

The microphone path, shown at the bottom half of the voice activation system 700 of FIG. 7, can include a microphone 740 and an echo cancellation engine 750. In some aspects, the echo cancellation engine 750 of FIG. 7 can be the same as or similar to one or more of the ECNS engine 406 of FIG. 4, the echo canceller 414 of FIG. 4, the noise suppressor 416 of FIG. 4, and/or the echo post-processor 418 of FIG. 4, etc.

The microphone 740 can be used to obtain a target user speech signal comprising one or more audio samples corresponding to an utterance (e.g., spoken keyword(s) or other words) by a user 741. When barge-in does not occur, audio playback concurrency by the speaker 730 is not present, and a microphone signal 742 obtained using the microphone 740 does not include an echo signal 736 or echo residual corresponding to audio playback from the speaker 730.

When barge-in occurs, the user utterance is concurrent with the audio playback by the speaker 730. For example, when barge-in does occur, audio playback concurrency by the speaker 730 is present, and the microphone signal 742 obtained using the microphone 740 includes the target user speech uttered by the user 741 and also includes the echo signal 736 corresponding to the output playback of the speaker 730.

The voice activation system 700 of FIG. 7 can include a voice activation engine 780, which may be the same as or similar to the voice activation system 120 of FIG. 1A. The voice activation engine 780 can include a user verification (UV) engine 782 and a keyword detection engine 784. In some aspects, the keyword detection engine 784 can be the same as or similar to the keyword detection first stage 200 of FIG. 2 and/or the keyword detection second stage 214 of FIG. 2. In some examples, the keyword detection engine 784 can be the same as or similar to the keyword detector 208 and/or the keyword detection model 212 of FIG. 2.

The user verification (UV) engine 782 can be configured to perform voice-based user verification to verify that the target user speech within the microphone signal 742 was uttered by the corresponding user 741. For example, the user verification engine 782 can perform voice-based user verification utilizing one or more representative features extracted or generated from the input audio samples provided to the voice activation engine 780. For instance, the user verification engine 782 can perform voice-based user verification based on an audio feature vector corresponding to the target user speech captured in the microphone signal 742. In some aspects, the audio feature vector for the target user speech can be the same as or similar to the audio feature vector 308 of FIG. 3. In some examples, the voice activation engine 780 of FIG. 7 can include a feature generator that is the same as or similar to the feature generator 204 of FIG. 2 and/or the feature generator 300 of FIG. 3. In some aspects, an audio data input to the user verification engine 782 can comprise one or more features extracted from the microphone signal 742 or EC.

The input audio samples provided to the voice activation engine 780 can be obtained from the microphone signal 742 (e.g., if echo cancellation engine 750 is not used) or can be obtained from a processed microphone signal generated as output from an echo cancellation process applied to the microphone signal 742 by the echo cancellation engine 750. The output of the echo cancellation engine 750 after performing echo cancellation and/or noise suppression for the microphone signal 742 can also be referred to as an echo canceled signal or an EC signal.

In one illustrative example, the user verification engine 782 can be configured to process one or more extracted features (e.g., such as audio feature vector 308 of FIG. 3) corresponding to the user 741 utterance captured by the microphone 740, where the extracted features are representative features corresponding to the voice of the unique user 741. For instance, the extracted features can represent one or more voice characteristics of the user 741. The extracted features can be processed by the user verification engine 782, for example utilizing a neural network or other trained machine learning network. Based on a comparison of the voice characteristics of the target user speech (e.g., captured by microphone 740 and represented within the extracted features), and known (e.g., learned) voice characteristics registered with the neural network or trained machine learning network, the user verification engine 782 may generate as output a prediction indicative of whether the utterance within microphone signal 742 was spoken by the target user 741.

The prediction from the user verification neural network 782 can include or comprise predicted confidence level information (e.g., a confidence score, etc.), where the confidence level information corresponds to a predicted degree of certainty that the utterance within microphone signal 742 was spoken by the voice of the target user 741.

In some aspects, the user verification engine 782 can be configured to perform the voice-based user verification by comparing the predicted confidence level information (e.g., generated based on analyzing the extracted features from the microphone signal 742 by the neural network or user voice model associated with the user verification engine 782) with a configured threshold value for verification. The configured threshold value for verification can also be referred to as a user verification threshold or a UV threshold. For example, a default UV threshold can be configured, where a user is verified as the speaker of the target user speech in microphone signal 742 based on the user verification engine 782 generating a predicted confidence level that is greater than or equal to the default UV threshold value. For instance, if the default UV threshold value is configured with a value of 60, a predicted confidence level value of 70 would result in successful or affirmative verification by the user verification engine 782 that the microphone signal 742 includes utterances by the user 741.

In some examples, the user is not verified as being the speaker of the target user speech in microphone signal 742 based on the user verification engine 782 generating a predicted confidence level that is less than the default UV threshold value configured for the voice activation engine 780. For instance, if the default UV threshold value is configured with a value of 60, a predicted confidence level value of 50 would result in an unsuccessful verification by the user verification engine 782 that the microphone signal 742 includes utterances by the user 741.

In the example where voice-based user verification is performed in combination with keyword detection by a voice activation engine, voice-based user verification can be performed prior to the keyword detection. For instance, if the user verification engine 782 verifies that the input speech is by the target user 741, the input audio samples to the voice activation engine 780 (or extracted features thereof) may subsequently proceed to processing by the keyword detection engine 784. If the user verification engine 782 does not verify that the input speech is by the target user 741, the input audio samples to the voice activation engine 780 (or extracted features thereof) can skip processing by the keyword detection engine 784, and the process of voice activation engine 780 can exit. In some examples, voice-based user verification can be performed in parallel with keyword detection (e.g., a voice activation engine may perform voice-based user verification and keyword detection in parallel). In some cases, if voice-based user verification processing completes before keyword detection processing, and corresponds to a rejected verification output, the voice activation engine can stop (e.g., perform early termination of) the keyword detection processing based on the rejected verification. In some cases, if keyword detection processing completes before voice-based user verification processing, and corresponds to a rejected keyword detection output, the voice activation engine can stop (e.g., perform early termination of) the voice-based user verification processing based on the rejected keyword detection.

In one illustrative example, the UV threshold for comparison with the predicted confidence level determined by the user verification engine 782 can be a static or default value. For instance, the “Original UV THR” shown in FIG. 7 can be a default UV threshold used by the user verification engine 782 to perform voice-based user verification. In some aspects, the default or original UV threshold value can be obtained by a user verification dynamic threshold engine 760, which can be configured to determine a dynamic UV threshold value for voice-based user verification performed by the user verification engine 782. The dynamic UV threshold value can be determined based on the original UV threshold value and echo cancellation information associated with echo cancellation performed by the echo cancellation engine 750 for the microphone signal 742.

In some aspects, the original UV threshold value is used by user verification engine 782 when barge-in does not occur. For example, in the absence of barge-in, the voice activation engine 780 can perform voice-based user verification using a baseline or default configured user verification (UV) threshold and using the microphone signal 742 as input.

When barge-in occurs or is present, the user verification dynamic threshold engine 760 can configure the user verification engine 782 to use an updated, dynamic UV threshold value that is lower (e.g., smaller) than the original UV threshold value. In some aspects, the offset between the dynamic UV threshold value (e.g., “Dynamic UV THR” shown in FIG. 7) and the original UV threshold value (e.g., “Original UV THR” shown in FIG. 7) can increase with the audio playback volume 715 of the speaker 730.

For example, as the playback volume 715 increases (e.g., as the echo 736 from the output of the echo reference by speaker 730), the user verification dynamic threshold engine 760 can set the dynamic UV threshold to a lower value. A lower value of the dynamic UV threshold corresponds to the user verification engine 782 successfully verifying the voice of the user 741 at a lower predicted confidence score, and can improve the accuracy and performance of the user verification engine 782 and voice activation engine 780 during instances of audio playback barge-in concurrent with the target user speech.

For example, as noted previously, the microphone path of the voice activation system 700 can implement the echo cancellation engine 750 to be upstream of the voice activation engine 780. The echo cancellation engine 750 can use the audio playback or output signal from the audio playback path as an echo reference signal for performing echo cancellation on the microphone signal 742.

The echo cancellation engine 750 may remove some, but not all, of the contribution of the echo 736 (e.g., associated with the occurrence of barge-in) from the microphone signal 742. In some cases, the echo canceled signal (EC signal) output by the echo cancellation engine 750 and received as input by the voice activation engine 780 and user verification engine 782 can include an echo residual and/or distortion that masks the target user speech uttered by the user 741 into the microphone 740.

The echo residual and/or distortion(s) that remain within the EC signal can correspond to relatively lower predicted confidence scores when performing voice-based user verification by processing the EC signal by the neural network user model of the user verification engine 782. The relatively lower predicted confidence score values correspond to a decreased success rate in the voice-based user verification performed by the user verification engine 782.

Relatively lower predicted confidence score values may be associated with echo residual and/or distortions included in the audio input to the user verification engine 782, as noted above, which may occur more frequently during barge-in scenarios than non-barge-in scenarios. Voice-based user verification may therefore be associated with a decreased rate of successful verification during barge-in scenarios.

In some cases, higher values of the audio playback volume 715 correspond to a higher echo residual contribution within the audio samples provided as input to the user verification engine 782, and a lower user verification detection rate. For example, when audio playback is enabled with a large volume setting (e.g., high playback volume level 715), there is more echo residual in the audio data received as input by the user verification engine 782. The increased in echo residual within the input audio data to the user verification engine 782 can correspond to lower user verification confidence scores for both the scenario in which the talker (e.g., user 741) is the target user and also the scenario in which the talker (e.g., user 741) is an imposter (e.g., not the target user).

In some aspects, the user verification dynamic threshold engine 760 can be used to configure the user verification engine 782 with different UV threshold values during barge-in cases (e.g., audio playback path and speaker 730 are active to output audio concurrent with the user 741 speech) and non-barge-in cases (e.g., audio playback path and speaker 730 are off or otherwise not active to output audio concurrent with the user 741 speech). In some cases, the user verification engine 782 can be configured to perform voice-based user verification utilizing a first UV threshold value corresponding to non-barge-in cases (e.g., the original UV THR value shown in FIG. 7), and utilizing a second UV threshold value corresponding to barge-in cases (e.g., the dynamic UV THR value shown in FIG. 7).

In some aspects, the second UV threshold value corresponding to barge-in cases (e.g., the dynamic UV THR) can be a static value that is different from the first UV threshold value and used for all playback volume levels 715 during barge-in.

In one illustrative example, the systems and techniques described herein can use the user verification dynamic threshold engine 760 to determine an updated, dynamic user verification threshold that is varied based at least in part on the playback volume 715 and/or the current volume level information of the audio playback path and speaker 730. For example, the systems and techniques can provide improved user verification detection performance during audio playback concurrency (e.g., barge-in) based on adjusting and/or fine-tuning the original UV threshold value to a lower, dynamic UV threshold value based on the playback volume 715 settings to improve user verification detection during barge-in use cases.

For example, the user verification dynamic threshold engine 760 can determine a dynamic UV threshold value based on mapping the current volume level of the playback volume 715 to a configured threshold offset value. The dynamic UV threshold value can be determined by subtracting the configured threshold offset for the current playback volume level 715 from the default or original UV threshold value used during non-barge-in cases. In some aspects, the user verification dynamic threshold engine 760 can implement the example mapping depicted in Table 1, below, to determine a threshold offset for generating the updated, dynamic UV threshold value from the original UV threshold value:

TABLE 1
Example mapping of current playback volume levels to
user verification threshold offsets for determining a dynamic
user verification threshold during barge-in.

| | Playback | User Verification Threshold |
|---|---|---|
| | Volume | Offset |
| No Barge-in | — | 0 |
| Yes Barge-in | Max Volume | 10 |
| | Max Volume-1 | 10 |
| | Max Volume-2 | 5 |
| | Max Volume-3 | 0 |
| | . . . | 0 |
| | Min Volume | 0 |

In some aspects, the user verification dynamic threshold engine 760 can determine a dynamic UV threshold value for voice-based user verification by the user verification engine 782, where higher current playback volume levels 715 correspond to lower dynamic UV threshold values. Decreasing the dynamic UV threshold value for the voice0based user verification by the user verification engine 782 can increase the user verification detection rate in scenarios of high volume level audio playback concurrency for a target user's speech, without significant impact to the imposter false alarm rate of the user verification engine 782.

In some examples, the voice activation system 700 can use a stored look-up table to obtain information indicative of the mapping between various playback volume levels 715 and a corresponding UV threshold offset. In some cases, the look-up table can be included within and/or stored by the voice activation system 700, the user verification dynamic threshold engine 760, and/or the voice activation engine 780. In some aspects, the stored look-up table can be the same as or similar to the example mapping of Table 1, above. In some aspects, a look-up table indicative of mapping information between playback volume levels 715 and corresponding user verification threshold offset values can be stored in a client application (e.g., mobile application, etc.) running on the same device that includes or implements the voice activation system 700.

In one illustrative example, the voice activation system 700 can detect when audio playback is enabled on the device. For example, the voice activation system 700 can detect when the audio playback path is active to output audio via speaker 730 with a non-zero playback volume level 715. In some cases, the voice activation system 700 and/or the voice activation engine 780 can be configured to detect a barge-in start time while audio playback is enabled, where the barge-in start time corresponds to the beginning of a barge-in instance of audio playback concurrency from speaker 730 while the microphone path is active to obtain a microphone signal 742 of target user speech from the user 741.

In some aspects, the voice activation system 700 and/or voice activation engine 780 can be configured to detect or determine that barge-in has started or is otherwise occurring at the current time. In response to determining that barge-in is occurring, the voice activation system 700 and/or the voice activation engine 780 can determine the current playback volume setting 715 for the audio playback from speaker 730. For instance, the current playback volume setting 715 can be determined using a query to a corresponding volume control API of the device, as noted previously.

Based on determining the current volume level setting 715 for the audio playback via speaker 730, the user verification dynamic threshold engine 760 can determine the corresponding offset for generating the dynamic UV threshold from the original UV threshold value. The user verification dynamic threshold engine 760 can reduce the original (e.g., non-barge-in) UV threshold value by the amount of the determined offset, to thereby generate the dynamic UV threshold value. The user verification engine 782 can then be configured to perform voice-based user verification based on the dynamic UV threshold value generated by the user verification dynamic threshold engine 760.

In some aspects, while the audio playback path is active (e.g., while audio playback is on, and the speaker 730 is outputting sound at a non-zero playback volume level 715), the user verification dynamic threshold engine 760 can monitor the audio playback volume 715 to identify any changes to increase or decrease the current volume level setting for the speaker 730. For instance, a change to increase or decrease the audio playback volume 715 can be identified by the voice activation system 700 or component thereof (e.g., user verification dynamic threshold engine 760, etc.), and/or can be identified by a client application running on the same device as used to implement the voice activation system 700. In response to detecting a change in the current volume level 715, the user verification dynamic threshold engine 760 can determine a corresponding updated UV threshold offset value, and can configure the user verification engine 782 with the updated dynamic UV threshold value. In some cases, the user verification engine 782 is configured with the updated dynamic UV threshold value prior to the beginning of barge-in (e.g., the dynamic UV threshold value can be configured while the microphone path remains inactive, and the microphone 740 is not obtaining a microphone signal 742 corresponding top target user speech).

In one illustrative example, the user verification dynamic threshold engine 760 can dynamically determine an adjusted value for the dynamic UV threshold for voice-based user verification during barge-in associated with audio playback concurrency. For example, the user verification dynamic threshold engine 760 can obtain (e.g., receive as input) echo cancellation information from the echo cancellation engine 750. In some aspects, the echo cancellation information can be indicative of information associated with echo cancellation and/or noise suppression processing performed by the echo cancellation engine 750 to generate the EC signal from the microphone signal 742.

For example, the echo cancellation information may be indicative of information associated with the echo residual included in the audio sample(s) of the EC signal provided from the echo cancellation engine 750 to the voice activation engine 780 and/or the voice-based user verification engine 782. In some examples, the echo cancellation information can be indicative of one or more of a signal-to-noise-ratio (SNR), a signal-to-echo-ratio (SER), and/or an echo-return-loss-enhancement (ERLE) associated with the echo cancellation performed by the echo cancellation engine 750. For example, the echo cancellation information can be indicative of an SNR, SER, and/or ERLE, etc., associated with an echo residual included in the audio sample(s) provided as input to the voice-based user verification engine 780 (e.g., an SNR, SER, and/or ERLE, etc., associated with an echo residual included in the EC signal). In some cases, the echo cancellation information may be indicative of an SNR, SER, and/or ERLE, etc., associated with the echo-canceled audio samples that are output by the echo cancellation engine 750 and provided as input to the voice-based user verification engine 782.

In some cases, the echo cancellation information can be indicative of an echo level associated with the echo 736 included within the microphone signal 742. In some cases, the echo cancellation information may be indicative of an echo level identified during echo cancellation processing by the echo cancellation engine 750 and/or by a DSP associated with the voice activation system 700. Various other DSP outputs associated with echo cancellation sound processing, noise suppression sound processing, and/or various other DSP sound processing operations applied to the microphone signal 742 and used to generate the EC signal provided as input to the user verification engine 782 may be provided as additional inputs to the user verification dynamic threshold engine 760 and used to determine an adjusted dynamic UV threshold value (or offset value from the original or default UV threshold value associated with non-barge-in cases).

In some examples, the user verification dynamic threshold engine 760 can include one or more neural networks and/or machine learning networks trained to generate as output the dynamic UV threshold value based on a set of inputs that includes audio playback path information (e.g., current playback volume level 715, characteristics of the echo reference signal, characteristics of the speaker 730, the currently active client application running on the device to cause the audio playback path to be active to output audio via speaker 730, etc.) and echo cancellation information from the echo cancellation engine 750 or associated DSP.

The systems and techniques described herein can be used to enable the optimal user verification threshold tuning for audio playback concurrency (e.g., barge-in) at different playback volumes and/or different playback conditions (e.g., including different echo cancellation information and/or different echo cancellation conditions, etc.). The dynamic tuning of the user verification confidence score threshold for verification can improve the consistency and accuracy of the voice-based user verification performed by the user verification engine 782, and can improve the user verification detection performance between audio playback on (e.g., barge-in) scenarios and audio playback off (e.g., non-barge-in) cases. In some aspects, the systems and techniques can be used for various types of user verification and/or various user verification techniques. For instance, the user verification dynamic threshold engine 760 can be used to determine an updated, dynamic UV threshold value for keyword-dependent user verification implementations, for text-independent user verification implementations, etc.

In some cases, the systems and techniques can be implemented at an application and/or software-level of the client device that includes the voice activation engine 780 and/or user verification engine 782. For example, the systems and techniques can be implemented at the application level using one or more OS-specific volume APIs. In another example, the systems and techniques can be implemented within the hardware abstraction layer (HAL) level of the client device including the voice activation engine 780 and/or user verification engine 782. In some aspects, for an Android or Linux-based client device, the systems and techniques can be implemented in the Sound Trigger HAL

(STHAL) level, such as in an STHAL voice activation (VA) architecture. In some examples, the systems and techniques can be implemented in a client application running on the client device, such as a client voice assistant application, a client voice activation application, etc.

In some cases, the audio playback volume information 715 for the current volume level can be obtained from a high-level operating system (HLOS) volume table maintained by the OS of the client device. In some cases, the audio playback volume information 715 for the current volume level can be obtained from one or more DSPs of the client device. In some examples, client applications can obtain playback volume information 715 using one or more corresponding queries and/or callbacks from an OS API of the client device.

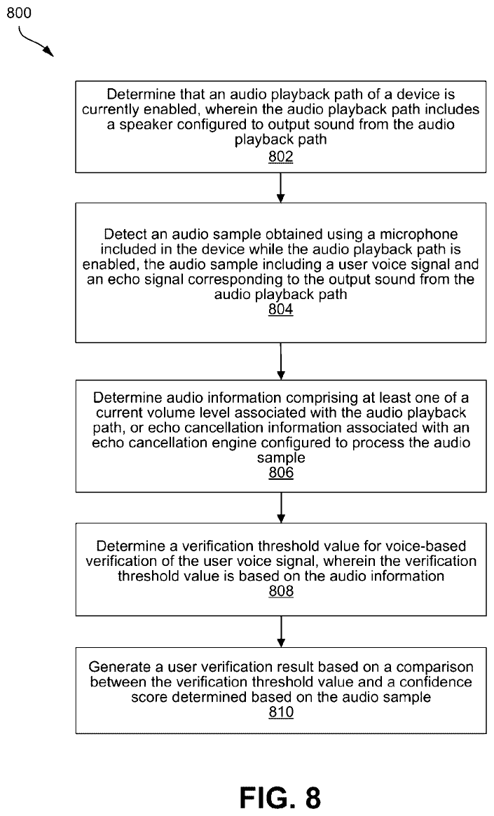

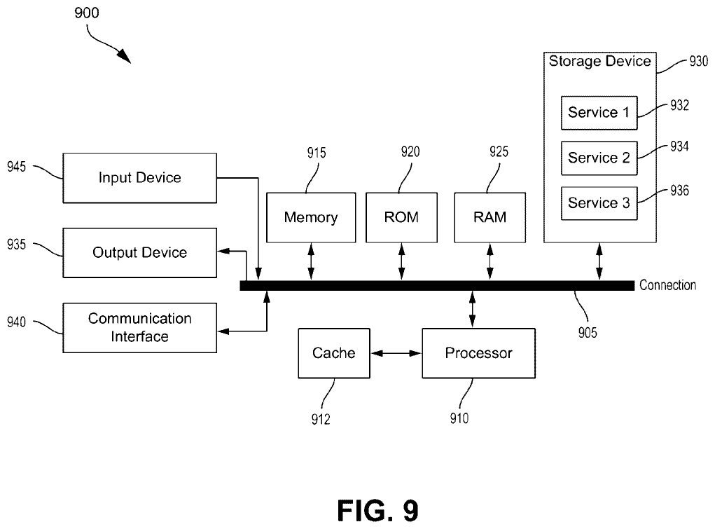

FIG. 8 is a flow chart illustrating an example of a process 800 for processing one or more audio samples. For instance, the process 800 can be a process for processing audio samples to perform user verification, including user verification for voice activation, user authentication, etc. The process 800 can be performed by a computing device or apparatus or a component or system (e.g., one or more chipsets, one or more processors such as one or more CPUs, DSPs, NPUs, NSPs, microcontrollers, ASICs, FPGAs, programmable logic devices, discrete gates or transistor logic components, discrete hardware components, etc., any combination thereof, and/or other component or system) of the computing device or apparatus. The operations of the process 800 may be implemented as software components that are executed and run on one or more processors (e.g., processor 910 of FIG. 9 or other processor(s)).

At block 802, the computing device (or component thereof) can determine that an audio playback path of a device is currently enabled, wherein the audio playback path includes a speaker configured to output sound from the audio playback path.

For example, the audio playback path can be the same as or similar to the audio playback path of FIG. 7, and the speaker can be the same as or similar to the speaker 730 of FIG. 7. In some examples, determining that the audio playback path is enabled comprises determining that the audio playback path is associated with a non-zero value for a current playback volume, such as the playback volume 715 of FIG. 7.

In some cases, the audio playback path can be included in a device that is the same as the apparatus used to implement the process 800. For example, the apparatus can be the device and can comprise the speaker and a microphone. In some examples, the apparatus can be part of the device.

At block 804, the computing device (or component thereof) can detect an audio sample obtained using a microphone included in the device while the audio playback path is enabled, the audio sample including a user voice signal and an echo signal corresponding to the output sound from the audio playback path.

For example, the audio sample can be the same as or similar to one or more audio samples associated with the target user speech of FIG. 7 and the user 741, and/or one or more audio samples of the microphone signal 742 of FIG. 7. In some examples, the microphone included in the device can be the same as or similar to the microphone 740 of FIG. 7.

In some examples, detecting an audio sample obtained using a microphone included in the device while the audio playback path is enabled can correspond to a barge-in, or detecting a barge-in (e.g., where the barge-in corresponds to audio playback concurrency with the audio sample obtained using the microphone). In some aspects, the audio sample obtained can be the same as or similar to an audio sample of the microphone signal 742 of FIG. 7. For example, the user voice signal included in the audio sample can be the same as or similar to the target user speech of the user 741 of FIG. 7, and the echo signal included in the audio sample can be the same as or similar to the echo signal 736 of FIG. 7. The echo signal corresponding to the output sound from the audio playback path can be an echo signal (e.g., echo signal 736 of FIG. 7) corresponding to an output sound from the speaker 730 of the audio playback path of FIG. 7, for example based on the echo reference signal of FIG. 7.

At block 806, the computing device (or component thereof) can determine audio information comprising at least one of a current volume level associated with the audio playback path, or echo cancellation information associated with an echo cancellation engine configured to process the audio sample.

For example, the audio information can be determined and/or obtained using the user verification dynamic threshold engine 760 of FIG. 7. In some cases, the current volume level associated with the audio playback path can be the same as or similar to the current volume level corresponding to the playback volume 715 of FIG. 7. In some examples, the echo cancellation information can be the same as or similar to the echo cancellation information obtained from the echo cancellation engine 750 of FIG. 7. For example, the echo cancellation engine 750 can be configured to process the audio sample.

In some examples, to determine the current volume level associated with the audio playback path, the computing device (or component thereof) can query an application programming interface (API) associated with the audio playback path. For example, the computing device (or component thereof) can query the API in response to detecting the audio sample while the audio playback path is enabled (e.g., in response to detecting barge-in).

In some cases, the echo cancellation information includes one or more of a signal-to-noise ratio (SNR) or a signal-to-echo-ratio (SER) associated with echo cancellation performed for the audio sample by the echo cancellation engine (e.g., the echo cancellation engine 750 of FIG. 7). In some examples, the echo cancellation information includes one or more of echo-return-loss-enhancement (ERLE) information or echo residual information associated with echo cancellation performed for the audio sample by the echo cancellation engine (e.g., the echo cancellation engine 750 of FIG. 7).

At block 808, the computing device (or component thereof) can determine a verification threshold value (e.g., a value for the dynamic verification threshold described herein) for voice-based verification of the user voice signal, wherein the verification threshold value is based on the audio information.

For example, the verification threshold value can be the same as or similar to the dynamic verification threshold value of FIG. 7 (e.g., the “Dynamic UV THR” of FIG. 7). In some cases, the voice-based verification of the user voice signal can be performed by a user verification engine the same as or similar to the user verification engine 782 of FIG. 7.

In some examples, to determine the verification threshold value, the computing device (or component thereof) can determine, based on the audio information, an offset value. For instance, the offset value can be determined based on the echo cancellation information and/or the current volume level information of FIG. 7. The computing device (or component thereof) can determine the verification threshold value based on subtracting the offset value from a configured verification threshold value. In some cases, the configured verification threshold value is greater than the verification threshold value. For example, the configured verification threshold value can be the same as or similar to the original UV THR of FIG. 7, and the verification threshold value can be the same as or similar to the dynamic UV THR of FIG. 7, etc.

In some examples, a relatively high current volume level associated with the audio playback path corresponds to a relatively small verification threshold value, and a relatively low current volume level associated with the audio playback path corresponds to a relatively high verification threshold value.

In some examples, a relatively high current volume level associated with the audio playback path corresponds to a relatively high verification threshold value, and a relatively low current volume level associated with the audio playback path corresponds to a relatively low verification threshold value.

In some cases, the verification threshold value is determined based on a look-up table mapping respective volume levels to corresponding verification threshold offset values. In some examples, to determine the verification threshold value, the computing device (or component thereof) can determine, based on the mapping of the look-up table, a verification threshold offset value corresponding to the current volume level, and can subtract the verification threshold offset value from a default verification threshold offset value associated with a voice-based user verification engine included in the apparatus. For example, the default verification threshold offset value can be associated with the original UV THR of FIG. 7. The voice-based user verification engine can be the same as or similar to the user verification engine 782 of FIG. 7.

In some examples, the computing device (or component thereof) can detect a change to the current volume level associated with the audio playback path. For example, the user verification dynamic threshold engine 760 of FIG. 7 can detect a change to the current volume level of the playback volume 715 of FIG. 7. The computing device (or component thereof) can update the verification threshold value based on the change to the current volume level associated with the audio playback path. For example, the dynamic UV THR of FIG. 7 can be updated based on a change to the current volume level of the playback volume 715 of FIG. 7.

In some examples, the computing device (or component thereof) can increase the verification threshold value based on detecting the change to the current volume level comprises a decrease. In some examples, the computing device (or component thereof) can decrease the verification threshold value based on detecting the change to the current volume level comprises an increase.

At block 810, the computing device (or component thereof) can generate a user verification result based on a comparison between the verification threshold value and a confidence score determined based on the audio sample. For example, the confidence score can be generated by the voice-based user verification engine 782 of FIG. 7. In some cases, the confidence score can correspond to and/or can be based on a voice model corresponding to the user, such as a voice model corresponding to the user 741 of FIG. 7.

In some cases, the computing device (or component thereof) can configure a voice-based user verification engine with the verification threshold value in response to detecting the audio sample while the audio playback path is enabled. For example, the user verification engine 782 of FIG. 7 can be configured with the dynamic UV THR value in response to detecting barge-in between the speaker 730 output of the audio playback path concurrent with the microphone signal input 742 of the target user speech to the microphone 740 of FIG. 7.

In some cases, the computing device (or component thereof) can configure a voice-based user verification engine (e.g., the user verification engine 782 of FIG. 7) with a configured verification threshold value (e.g., the original UV THR of FIG. 7) in response to not detecting the audio sample while the audio playback path is enabled. In some examples, the configured verification threshold value comprises a static or default verification threshold value associated with a non-barge-in case.

In some examples, the computing device (or component thereof) can generate the user verification result using a voice-based user verification engine (e.g., user verification engine 782 of the voice activation engine 780 of FIG. 7) configured by the verification threshold value.

In some cases, the computing device (or component thereof) can process, using the echo cancellation engine, the audio sample to thereby generate an echo canceled audio sample. For example, the microphone signal 742 of FIG. 7 can be processed using the echo cancellation engine 750 of FIG. 7, to thereby generate an echo canceled audio sample (e.g., provided to the voice activation engine 780 by the echo cancellation engine 750). In some examples, the computing device (or component thereof) can process, using a voice-based user verification engine (e.g., the user verification engine 782 of FIG. 7), the echo canceled audio sample to thereby generate the confidence score.

In some cases, an apparatus used to implement the process 800 can include microphone configured to obtain the one or more audio samples. In some cases, the apparatus further comprises one or more microphones configured to capture the one or more audio samples for keyword detection and/or user voice verification. In some examples, the one or more microphones and the first keyword detection model are associated with an always-on keyword detection process and/or user voice verification process implemented by the apparatus.

In some examples, as noted previously, the processes described herein (e.g., process 800 of FIG. 8, and/or other processes described herein) can be performed, in whole or in part, by a computing device or apparatus. In one example, one or more of the processes described herein can be performed by the speech recognition system 100 of FIG. 1A, the voice activation system 90 of FIG. 1A, the user computing device 150 and/or the user device computing system 170 of FIG. 1B, the communication device 402 of FIG. 4, and/or the voice activation system 700 of FIG. 7, etc.

In another example, one or more of the processes (e.g., process 800 of FIG. 8, and/or other processes described herein) can be performed, in whole or in part, by the computing-device architecture 900 shown in FIG. 9. For instance, a computing device with the computing-device architecture 900 shown in FIG. 9 can include, or be included in, the components of the speech recognition system 100 of FIG. 1A, the voice activation system 90 of FIG. 1A, the user computing device 150 and/or the user device computing system 170 of FIG. 1B, the communication device 402 of FIG. 4, and/or the voice activation system 700 of FIG. 7, etc., and can implement the operations of process 800 of FIG. 8, and/or other processes described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of a device configured to perform the process 800 of FIG. 8 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 800 is illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 800 and/or other processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

In some aspects, training of one or more of the machine learning systems or neural networks described herein (e.g., a neural network implementing the feature generation and/or keyword detection process(es) shown in FIG. 2, the feature generation shown in FIG. 3, the echo cancellation shown in FIG. 4, the user verification dynamic threshold adjustment and/or user voice verification system shown in FIG. 7, among various other machine learning networks described with respect to FIGS. 2-7, etc.) can be performed using online training, offline training, and/or various combinations of online and offline training. In some cases, online may refer to time periods during which the input data (e.g., one or more audio samples, one or more audio and/or speech features or feature vectors, etc., describes with respect to FIGS. 2-7, etc.) is processed, for instance for performance of the user voice verification with dynamic threshold(s) implemented by the systems and techniques described herein. In some examples, offline may refer to idle time periods or time periods during which input data is not being processed. Additionally, offline may be based on one or more time conditions (e.g., after a particular amount of time has expired, such as a day, a week, a month, etc.) and/or may be based on various other conditions such as network and/or server availability, etc., among various others.

FIG. 9 illustrates an example computing-device architecture 900 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 900 may include, implement, or be included in any or all of the speech recognition system 100 of FIG. 1A, the voice activation system 90 of FIG. 1A, the user computing device 150 and/or the user device computing system 170 of FIG. 1B, the communication device 402 of FIG. 4, and/or the voice activation system 700 of FIG. 7, etc. Additionally or alternatively, computing-device architecture 900 may be configured to perform process 900 of FIG. 9, and/or other process described herein.

The components of computing-device architecture 900 are shown in electrical communication with each other using connection 912, such as a bus. The example computing-device architecture 900 includes a processing unit (CPU or processor) 902 and computing device connection 912 that couples various computing device components including computing device memory 910, such as read only memory (ROM) 908 and random-access memory (RAM) 906, to processor 902.

The computing system 900, may be for example any computing device making up an internal computing system, a remote computing system, a camera, or any component thereof in which the components of the system are in communication with each other using connection 905. Connection 905 may be a physical connection using a bus, or a direct connection into processor 910, such as in a chipset architecture. Connection 905 may also be a virtual connection, networked connection, or logical connection.

In some aspects, computing system 900 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example system 900 includes at least one processing unit (CPU or processor) 910 and connection 905 that communicatively couples various system components including system memory 915, such as read-only memory (ROM) 920 and random access memory (RAM) 925 to processor 910. Computing system 900 may include a cache 915 of high-speed memory connected directly with, in close proximity to, or integrated as part of processor 910.

Processor 910 may include any general-purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which may represent any number of input mechanisms, such as a microphone for speech, a touch-sensitive screen for gesture or graphical input, keyboard, mouse, motion input, speech, etc. Computing system 900 may also include output device 935, which may be one or more of a number of output mechanisms. In some instances, multimodal systems may enable a user to provide multiple types of input/output to communicate with computing system 900.

Computing system 900 may include communications interface 940, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 930 may include software services, servers, services, etc., that when the code that defines such software is executed by the processor 910, it causes the system to perform a function. In some aspects, a hardware service that performs a particular function may include the software component stored in a computer-readable medium in connection with the necessary hardware components, such as processor 910, connection 905, output device 935, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. An apparatus configured to process audio data, the apparatus comprising: one or more memories configured to store the audio data; and one or more processors coupled to the one or more memories, the one or more processors being configured to: determine that an audio playback path of a device is currently enabled, wherein the audio playback path includes a speaker configured to output sound from the audio playback path; detect an audio sample obtained using a microphone included in the device while the audio playback path is enabled, the audio sample including a user voice signal and an echo signal corresponding to the output sound from the audio playback path; determine audio information comprising at least one of a current volume level associated with the audio playback path, or echo cancellation information associated with an echo cancellation engine configured to process the audio sample; determine a verification threshold value for voice-based verification of the user voice signal, wherein the verification threshold value is based on the audio information; and generate a user verification result based on a comparison between the verification threshold value and a confidence score determined based on the audio sample.

Aspect 2. The apparatus of Aspect 1, wherein the one or more processors are configured to: configure a voice-based user verification engine with the verification threshold value in response to detecting the audio sample while the audio playback path is enabled.

Aspect 3. The apparatus of any of Aspects 1 to 2, wherein the one or more processors are configured to: configure a voice-based user verification engine with a configured verification threshold value in response to not detecting the audio sample while the audio playback path is enabled.

Aspect 4. The apparatus of Aspect 3, wherein the configured verification threshold value comprises a static or default verification threshold value associated with a non-barge-in case.

Aspect 5. The apparatus of any of Aspects 1 to 4, wherein the one or more processors are configured to: generate the user verification result using a voice-based user verification engine configured by the verification threshold value.

Aspect 6. The apparatus of any of Aspects 1 to 5, wherein, to determine the verification threshold value, the one or more processors are configured to: determine, based on the audio information, an offset value; and determine the verification threshold value based on subtracting the offset value from a configured verification threshold value.

Aspect 7. The apparatus of Aspect 6, wherein the configured verification threshold value is greater than the verification threshold value.

Aspect 8. The apparatus of any of Aspects 1 to 7, wherein: a relatively high current volume level associated with the audio playback path corresponds to a relatively small verification threshold value; and a relatively low current volume level associated with the audio playback path corresponds to a relatively high verification threshold value.

Aspect 9. The apparatus of any of Aspects 1 to 8, wherein the one or more processors are configured to: process, using the echo cancellation engine, the audio sample to thereby generate an echo canceled audio sample; and process, using a voice-based user verification engine, the echo canceled audio sample to thereby generate the confidence score.

Aspect 10. The apparatus of any of Aspects 1 to 9, wherein the echo cancellation information includes one or more of a signal-to-noise ratio (SNR) or a signal-to-echo-ratio (SER) associated with echo cancellation performed for the audio sample by the echo cancellation engine.

Aspect 11. The apparatus of any of Aspects 1 to 10, wherein the echo cancellation information includes one or more of echo-return-loss-enhancement (ERLE) information or echo residual information associated with echo cancellation performed for the audio sample by the echo cancellation engine.

Aspect 12. The apparatus of any of Aspects 1 to 11, wherein the verification threshold value is determined based on a look-up table mapping respective volume levels to corresponding verification threshold offset values.

Aspect 13. The apparatus of Aspect 12, wherein, to determine the verification threshold value, the one or more processors are configured to: determine, based on the mapping of the look-up table, a verification threshold offset value corresponding to the current volume level; and subtract the verification threshold offset value from a default verification threshold offset value associated with a voice-based user verification engine included in the apparatus.

Aspect 14. The apparatus of any of Aspects 1 to 13, wherein, to determine the current volume level associated with the audio playback path, the one or more processors are configured to: query an application programming interface (API) associated with the audio playback path.

Aspect 15. The apparatus of Aspect 14, wherein the one or more processors are configured to query the API in response to detecting the audio sample while the audio playback path is enabled.

Aspect 16. The apparatus of any of Aspects 1 to 15, wherein the one or more processors are configured to: detect a change to the current volume level associated with the audio playback path; and update the verification threshold value based on the change to the current volume level associated with the audio playback path.

Aspect 17. The apparatus of Aspect 16, wherein the one or more processors are configured to: increase the verification threshold value based on detecting the change to the current volume level comprises a decrease; or decrease the verification threshold value based on detecting the change to the current volume level comprises an increase.

Aspect 18. The apparatus of any of Aspects 1 to 17, wherein the apparatus is the device and comprises the speaker and the microphone.

Aspect 19. The apparatus of any of Aspects 1 to 18, wherein the apparatus is part of the device.

Aspect 20. A processor-implemented method for processing audio data, comprising: determining that an audio playback path of a device is currently enabled, wherein the audio playback path includes a speaker configured to output sound from the audio playback path; detecting an audio sample obtained using a microphone included in the device while the audio playback path is enabled, the audio sample including a user voice signal and an echo signal corresponding to the output sound from the audio playback path; determining audio information comprising at least one of a current volume level associated with the audio playback path, or echo cancellation information associated with an echo cancellation engine configured to process the audio sample; determining a verification threshold value for voice-based verification of the user voice signal, wherein the verification threshold value is based on the audio information; and generating a user verification result based on a comparison between the verification threshold value and a confidence score determined based on the audio sample.

Aspect 21. The processor-implemented method of Aspect 20, further comprising: configuring a voice-based user verification engine with the verification threshold value in response to detecting the audio sample while the audio playback path is enabled.

Aspect 22. The processor-implemented method of any of Aspects 20 to 21, further comprising: configuring a voice-based user verification engine with a configured verification threshold value in response to not detecting the audio sample while the audio playback path is enabled.

Aspect 23. The processor-implemented method of Aspect 22, wherein the configured verification threshold value comprises a static or default verification threshold value associated with a non-barge-in case.

Aspect 24. The processor-implemented method of any of Aspects 20 to 23, further comprising: generating the user verification result using a voice-based user verification engine configured by the verification threshold value.

Aspect 25. The processor-implemented method of any of Aspects 20 to 24, wherein determining the verification threshold value includes: determining, based on the audio information, an offset value; and determining the verification threshold value based on subtracting the offset value from a configured verification threshold value.

Aspect 26. The processor-implemented method of Aspect 25, wherein the configured verification threshold value is greater than the verification threshold value.

Aspect 27. The processor-implemented method of any of Aspects 20 to 26, wherein: a relatively high current volume level associated with the audio playback path corresponds to a relatively small verification threshold value; and a relatively low current volume level associated with the audio playback path corresponds to a relatively high verification threshold value.

Aspect 28. The processor-implemented method of any of Aspects 20 to 27, further comprising: processing, using the echo cancellation engine, the audio sample to thereby generate an echo canceled audio sample; and processing, using a voice-based user verification engine, the echo canceled audio sample to thereby generate the confidence score.

Aspect 29. The processor-implemented method of any of Aspects 20 to 28, wherein the echo cancellation information includes one or more of a signal-to-noise ratio (SNR) or a signal-to-echo-ratio (SER) associated with echo cancellation performed for the audio sample by the echo cancellation engine.

Aspect 30. The processor-implemented method of any of Aspects 20 to 29, wherein the echo cancellation information includes one or more of echo-return-loss-enhancement (ERLE) information or echo residual information associated with echo cancellation performed for the audio sample by the echo cancellation engine.

Aspect 31. The processor-implemented method of any of Aspects 20 to 30, wherein the verification threshold value is determined based on a look-up table mapping respective volume levels to corresponding verification threshold offset values.

Aspect 32. The processor-implemented method of Aspect 31, wherein determining the verification threshold value includes: determining, based on the mapping of the look-up table, a verification threshold offset value corresponding to the current volume level; and subtracting the verification threshold offset value from a default verification threshold offset value associated with a voice-based user verification engine included in the device.

Aspect 33. The processor-implemented method of any of Aspects 20 to 32, wherein determining the current volume level associated with the audio playback path includes: querying an application programming interface (API) associated with the audio playback path.

Aspect 34. The processor-implemented method of Aspect 33, querying the API is in response to detecting the audio sample while the audio playback path is enabled.

Aspect 35. The processor-implemented method of any of Aspects 20 to 34, further comprising: detecting a change to the current volume level associated with the audio playback path; and updating the verification threshold value based on the change to the current volume level associated with the audio playback path.

Aspect 36. The processor-implemented method of Aspect 35, further comprising: increasing the verification threshold value based on detecting the change to the current volume level comprises a decrease; or decreasing the verification threshold value based on detecting the change to the current volume level comprises an increase.

Aspect 37. A non-transitory computer-readable storage medium comprising instructions stored thereon which, when executed by at least one processor, causes the at least one processor to perform operations according to any of Aspects 1 to 19.

Aspect 38. A non-transitory computer-readable storage medium comprising instructions stored thereon which, when executed by at least one processor, causes the at least one processor to perform operations according to any of Aspects 20 to 36.

Aspect 39. An apparatus comprising one or more means for performing operations according to any of Aspects 1 to 19.

Aspect 40. An apparatus comprising one or more means for performing operations according to any of Aspects 20 to 36.

What is claimed is:

1. An apparatus configured to process audio data, the apparatus comprising:
one or more memories configured to store the audio data; and
one or more processors coupled to the one or more memories, the one or more processors being configured to:
determine that an audio playback path of a device is currently enabled, wherein the audio playback path includes a speaker configured to output sound from the audio playback path;
detect an audio sample obtained using a microphone included in the device while the audio playback path is enabled, the audio sample including a user voice signal and an echo signal corresponding to the output sound from the audio playback path;
determine audio information comprising at least one of a current volume level associated with the audio playback path, or echo cancellation information associated with an echo cancellation engine configured to process the audio sample;
determine a verification threshold value for voice-based verification of the user voice signal, wherein the verification threshold value is based on the audio information; and
generate a user verification result based on a comparison between the verification threshold value and a confidence score determined based on the audio sample.

2. The apparatus of claim 1, wherein the one or more processors are configured to:
configure a voice-based user verification engine with the verification threshold value in response to detecting the audio sample while the audio playback path is enabled.

3. The apparatus of claim 1, wherein the one or more processors are configured to:
configure a voice-based user verification engine with a configured verification threshold value in response to not detecting the audio sample while the audio playback path is enabled.

4. The apparatus of claim 3, wherein the configured verification threshold value comprises a static or default verification threshold value associated with a non-barge-in case.

5. The apparatus of claim 1, wherein the one or more processors are configured to:
generate the user verification result using a voice-based user verification engine configured by the verification threshold value.

6. The apparatus of claim 1, wherein, to determine the verification threshold value, the one or more processors are configured to:
determine, based on the audio information, an offset value; and
determine the verification threshold value based on subtracting the offset value from a configured verification threshold value.

7. The apparatus of claim 6, wherein the configured verification threshold value is greater than the verification threshold value.

8. The apparatus of claim 1, wherein:
a relatively high current volume level associated with the audio playback path corresponds to a relatively small verification threshold value; and
a relatively low current volume level associated with the audio playback path corresponds to a relatively high verification threshold value.

9. The apparatus of claim 1, wherein the one or more processors are configured to:
process, using the echo cancellation engine, the audio sample to thereby generate an echo canceled audio sample; and
process, using a voice-based user verification engine, the echo canceled audio sample to thereby generate the confidence score.

10. The apparatus of claim 1, wherein the echo cancellation information includes one or more of a signal-to-noise ratio (SNR) or a signal-to-echo-ratio (SER) associated with echo cancellation performed for the audio sample by the echo cancellation engine.

11. The apparatus of claim 1, wherein the echo cancellation information includes one or more of echo-return-loss-enhancement (ERLE) information or echo residual information associated with echo cancellation performed for the audio sample by the echo cancellation engine.

12. The apparatus of claim 1, wherein the verification threshold value is determined based on a look-up table mapping respective volume levels to corresponding verification threshold offset values.

13. The apparatus of claim 12, wherein, to determine the verification threshold value, the one or more processors are configured to:
determine, based on the mapping of the look-up table, a verification threshold offset value corresponding to the current volume level; and
subtract the verification threshold offset value from a default verification threshold offset value associated with a voice-based user verification engine included in the apparatus.

14. The apparatus of claim 1, wherein, to determine the current volume level associated with the audio playback path, the one or more processors are configured to:
query an application programming interface (API) associated with the audio playback path.

15. The apparatus of claim 14, wherein the one or more processors are configured to query the API in response to detecting the audio sample while the audio playback path is enabled.

16. The apparatus of claim 1, wherein the one or more processors are configured to:
detect a change to the current volume level associated with the audio playback path; and
update the verification threshold value based on the change to the current volume level associated with the audio playback path.

17. The apparatus of claim 16, wherein the one or more processors are configured to:
increase the verification threshold value based on detecting the change to the current volume level comprises a decrease; or
decrease the verification threshold value based on detecting the change to the current volume level comprises an increase.

18. The apparatus of claim 1, wherein the apparatus is the device and comprises the speaker and the microphone.

19. The apparatus of claim 1, wherein the apparatus is part of the device.

20. A processor-implemented method for processing audio data, comprising:
determining that an audio playback path of a device is currently enabled, wherein the audio playback path includes a speaker configured to output sound from the audio playback path;
detecting an audio sample obtained using a microphone included in the device while the audio playback path is enabled, the audio sample including a user voice signal and an echo signal corresponding to the output sound from the audio playback path;
determining audio information comprising at least one of a current volume level associated with the audio playback path, or echo cancellation information associated with an echo cancellation engine configured to process the audio sample;
determining a verification threshold value for voice-based verification of the user voice signal, wherein the verification threshold value is based on the audio information; and
generating a user verification result based on a comparison between the verification threshold value and a confidence score determined based on the audio sample.
